(19) United States
(12) Patent Application Publication
(10) Pub. No.: US 2018/0016082 A1
(43) Pub. Date: Jan. 18, 2018

(54) User-Configurable Flavoring System

(71) Applicants: Raza Bashir, Oakville (CA); Craig Wissent, Oakville (CA); Gustavo Galaz, Oakville (CA); Andrew Edwards, Oakville (CA)

(72) Inventors: Raza Bashir, Oakville (CA); Craig Wissent, Oakville (CA); Gustavo Galaz, Oakville (CA); Andrew Edwards, Oakville (CA)

(73) Assignee: Northern Innovations Holding Corp., Oakville (CA)

(21) Appl. No.: 15/265,076

(22) Filed: Sep. 14, 2016

Related U.S. Application Data
(60) Provisional application No. 62/218,148, filed on Sep. 14, 2015.

(51) Int. Cl. B65D 81/32; B65D 43/02; B65D 25/04; B65D 43/16

(52) U.S. Cl. CPC B65D 81/3294; B65D 43/16; B65D 43/0225; A23L 27/00; B65D 25/04; A23L 5/00; A23V 2002/00

(57) ABSTRACT

A user-configurable flavoring module is provided. The multi-flavoring module supplies multiple individual flavor compositions that may be used to flavor foodstuffs, particularly nutritional supplements. The multi-flavoring module may be provided separately or together with the foodstuff to be flavored and provides for individual or combinations of flavorings to flavor the foodstuff variably, on a per serving basis, readily changing the flavor and flavor intensity.

### FIELD OF THE INVENTION

The present invention relates generally to user-configurable flavoring systems for foodstuffs. More specifically, the present invention relates to user-configurable flavoring systems for nutritional supplements for customizing the flavor of a nutritional supplement and containers for such supplements and systems.

### BACKGROUND OF THE INVENTION

Flavoring is an important aspect of consumed products such as food, beverages, and nutritional supplements. Nutritional supplements such as protein powders are often used to supplement the diet of an individual and are provided in one of several flavors. If there is no opportunity to sample or taste the nutritional supplement, there is a risk of purchasing an unpleasant or undesirable tasting product, often in a large amount. Often, individuals will add additional foodstuffs and ingredients to a nutritional supplement to change the macro- and micro-nutrient profile of the nutritional supplement and/or to change or enhance the flavor. However, it is often undesirable to change the macro- and micro-nutrient profile of a nutritional supplement, while the need for preferred taste/flavor is still important.

### SUMMARY OF THE INVENTION

A system of customizable flavoring of a foodstuff is provided by providing a plurality of segmented flavor compositions. The plurality of segmented flavor compositions may be used to vary the flavoring of portions of the foodstuff.

In an embodiment of the invention, there is provided a multi-flavoring module comprising a closure such as a lid and a main compartment, the main compartment configured to house a plurality of individual flavor compositions for flavoring, on a per-serving basis, a desired foodstuff and the closure or lid configured to allow repeated access to the main compartment. In some aspects, the multi-flavoring module contains a plurality of individual flavor compositions each in a separate sub-container. In other aspects, the multi-flavoring module contains a plurality of individual flavor compositions each in a separate subsection.

In another embodiment of the invention, there is provided a customizable multi-flavoring system comprising a foodstuff to be flavored provided in a base container and a multi-flavoring module comprising a lid and a main compartment, the main compartment configured to house a plurality of individual flavor compositions for flavoring, on a per-serving basis, the foodstuff.

In another embodiment of the invention, there is provided a method of customizable flavoring of a serving of a foodstuff by providing the foodstuff with a plurality of individual flavor compositions, allowing the user to change the flavor, on a per-serving basis.

### BRIEF DESCRIPTION OF THE DRAWINGS

Embodiments will now be described, by way of example only, with reference to the attached Figures, wherein:

FIG. 1 shows a perspective view of a multi-flavoring module having a closed lid according to one embodiment.

FIG. 2 shows the multi-flavoring module of FIG. 1, absent the lid.

### DETAILED DESCRIPTION OF THE EMBODIMENTS

The above-described embodiments are intended to be examples of the present invention and alterations and modifications may be effected thereto, by those of skill in the art. The scope of the claims should not be limited by the preferred embodiments set forth in the examples, but should be given the broadest interpretation consistent with the description as a whole.

The present invention provides, in one aspect, a multi-flavoring module having a main compartment for containing a plurality of individual flavor compositions. The multi-flavoring module may be provided independently for use with any desired foodstuff, preferably a nutritional supplement. In another aspect, the present invention provides a flavoring system having two main components: 1) an unflavored, neutral, or natural flavored foodstuff, preferably a nutritional supplement base component, provided in a base container, and 2) a multi-flavoring composition component provided in a multi-flavoring module having a main compartment for containing a plurality of individual flavor compositions. The neutral or natural flavored foodstuff or nutritional supplement base may be any foodstuff or nutritional supplement composition that preferably has a low flavor profile and the multi-flavoring module contains a plurality of flavor compositions and is used to flavor the foodstuff or nutritional supplement, preferably on a per serving basis.

The preferred foodstuff is a nutritional supplement in the form of a nutritional supplement base. The nutritional supplement base may be any nutritional supplement that, preferably, has a low flavor profile and may be unflavored, natural flavored, or neutral flavored. Suitable nutritional supplements for the nutritional supplement base include but are not limited to proteins or protein blend supplements, pre-workout supplements, post-workout supplements, and weight loss/management supplements. The preferred nutritional supplement base is a protein supplement. Such protein supplements may contain a single protein type such as whey protein, casein, soy, or rice protein. Such protein supplements may also contain blends or mixtures of two or more protein types. The nutritional supplement base may be a powder or a liquid but is preferably a powder.

The nutritional supplement base is provided in a base container and may be a conventional container suitable for the particular supplement composition. For example, most powdered nutritional supplements are provided in plastic tubs of suitable size to contain the nutritional supplement base along with a dispensing device, typically a plastic scoop, to facilitate dispensing a measured amount of the nutritional supplement base. Such conventional containers are typically sealed with a screw top. Alternatively, the nutritional supplement base container may be structurally modified in a way to facilitate attachment of, or association with, the multi-flavoring module, such as having a portion modified to match and associate with a complementary modified portion of the multi-flavoring module such as mating ridges and recesses.

The multi-flavoring module may be sold separately for use with any foodstuff or nutritional supplement base but is, preferably, sold as part of a kit containing both the foodstuff or nutritional supplement base and the multi-flavoring module. As a kit, the components may packaged in a common box/carton, or the multi-flavoring module may be affixed to the foodstuff or nutritional supplement base container by, for example, shrink wrapping, preferably on top and flush with the lid of the nutritional supplement base container.

The multi-flavoring module contains the multi-flavoring composition as multiple individual flavoring compositions that can be used to flavor the foodstuff or nutritional supplement base, on a per serving basis, with individual flavors in desired amounts for the desired flavor and flavor intensity. Alternatively, two or more flavors can be mixed in desired relative amounts to produce many different flavors at the desired intensity. Advantageously, this allows the user, or purchaser, of the foodstuff or nutritional supplement base (contained in the base container) and the multi-flavoring composition (contained in the multi-flavoring module) to frequently change or alter the flavor of the foodstuff or nutritional supplement base composition on a per serving basis. The flavors may include any flavors, sweet or savory, particularly those known and common in the art and suitable for the specific foodstuff or nutritional supplement base. Examples of such flavors, particularly for nutritional supplements, include: vanilla, chocolate, milk chocolate, dark chocolate, white chocolate, fudge, mocha, coffee, cappuccino, malt, mint, peppermint, cinnamon, caramel, toffee, cheesecake, brownie, rocky road, s'mores, marshmallow, cookies & cream, cookie dough, shortbread, granola, peanut butter, pretzel, graham cracker, blueberry, banana, strawberry, grape, lemon, lime, orange, apple, green apple, pineapple, coconut, peach, and fruit-punch, or combinations/variations thereof.

The multi-flavoring module may contain any number of individual flavor components. Preferred numbers of individual flavor components include any number of flavors from four to ten, which is a commercially practical number that allows for a great deal of flexibility and variety in flavoring options when used individually and in combination. Larger numbers of individual flavoring components may be used in the multi-flavoring module; however this may potentially increase the production and shipping costs as well as increase potential waste from unused flavor components.

The multi-flavoring module may be of any suitable size and shape to accommodate the desired number of individual flavor components, each in the desired amounts, and to facilitate being supplied with the foodstuff or nutritional supplement base container. Each individual flavor component may be provided in a separate sub-container within the main compartment or may be provided in a separate subsection, or sub-compartment, of the multi-flavoring module main compartment. Preferably, each individual sub-container or subsection should hold about 20 g to 30 g; however each individual sub-container or subsection may hold any amount necessary depending on the concentration of the flavor compositions and the amount of the nutritional supplement base. The multi-flavoring module may be sealed by means known in the art such as a screw top lid or a flip top lid. In the case of a flip top, the top may be configured as a single piece allowing simultaneous access to all subsections. Alternatively, the top may be configured as a flip top allowing each individual subsection to be opened individually. In a preferred embodiment, the top comprises a single sub-top or sub-lid, which can be rotated or otherwise manipulated to allow access to a single individual sub-compartment or subsection, while all other sub-compartments or subsections remain sealed. In this embodiment, the sub-top or sub-lid may open in any manner to allow access to one individual sub-compartment or subsection. For example, the sub-top or sub-lid may preferably comprise a pourable spout/nozzle or may open as flip top or screw top. In another preferred embodiment, the top comprises a plurality of sub-tops or sub-lids, each of which can be opened individually to allow access to an individual sub-compartment or subsection, while all other sub-compartments or subsections remain sealed. In this embodiment, each individual sub-top or sub-lid may open in any manner to allow access to one individual sub-compartment or subsection. For example, each sub-top or sub-lid may preferably comprise a pourable spout/nozzle or may open as flip top or screw top.

The top and/or the sub-tops or sub-lids may be labeled or may be transparent in order to allow the user to select the desired flavor sub-compartment or subsection, and to allow the user to determine when a sub-compartment or subsection needs to be refilled.

In one embodiment, the multi-flavoring module may be a container comprising a main compartment of any desired shape that houses the individual flavor components, each in their own sub-container such as, for example, a pod. The individual sub-containers may be of any shape and is preferably shaped to efficiently fit with the multi-flavoring module and be easily removed and returned. Each individual sub-container is provided with a means of opening the sub-container (i.e., a sub-top or sub-lid), removing a desired amount of flavoring composition, for example, by scooping or by pouring, and closing the sub-container. For example, the multi-flavoring module may be a tube or sleeve that houses a row of multiple pods, each pod containing a different flavor composition and being labeled or colored to facilitate identification. In this example the tube or sleeve may open in any suitable way, such as opening at one or both ends, or it may have a hinged opening along its length. Alternatively, the multi-flavoring module may contain subdivisions, providing, i.e., subsections or sub-containers for housing individual flavor components. In one such embodiment, the multi-flavoring module main compartment may be a disc-shaped or pie-shaped container subdivided into pie sections, each subsection containing a different individual flavor composition. The subdivisions may be structural elements contiguous with the main compartment or may be distinct structural elements configured to fit to prevent or minimize cross-contamination of flavoring compositions among subsections.

The multi-flavoring module may include a small scoop to facilitate dispensing to flavorings. The module may be configured to store the scoop in one of the plurality of subsections or may have a distinct compartment configured to store the scoop. Alternatively, the multi-flavoring module may be configured to selectably pour desired flavorings from specific subsections. In such configurations, the multi-flavoring module lid may be configured with a rotatable lid portion having a sealable pour spout/nozzle configured to be dialed to a specific subsection. In the case of sub-containers, each sub-container may be configured to open for pouring or scooping the flavoring.

Regardless of the configuration of the multi-flavoring module, it is desirable to minimize cross-contamination between flavors. In the case of separate sub-containers the risk of cross-contamination is minimal. However, in the case of a module with subsections, additional structural features may be included to reduce cross-contamination. In general, for a multi-flavoring module with subsections, a flip top presents less risk of cross-contamination than a screw top, particularly if each subsection is configured with its own flip top section. Structural elements may be included on the underside of the lid to cooperate with included structural elements of the module main compartment to minimize cross-contamination.

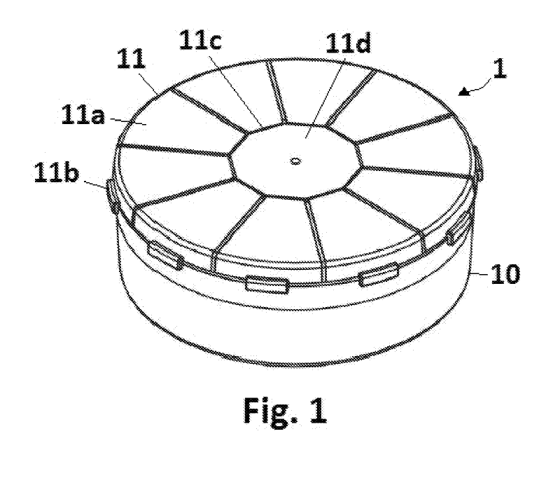

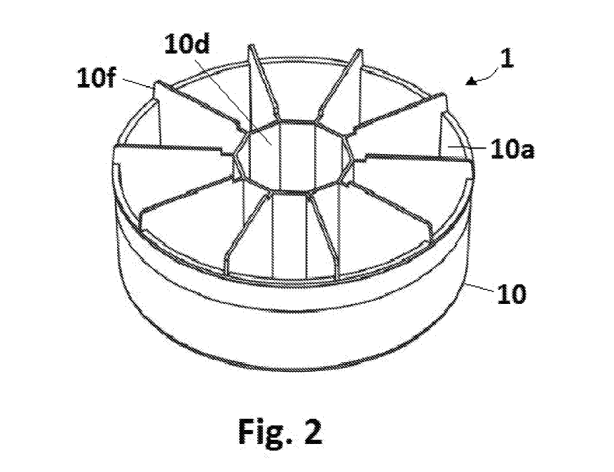

Now with reference to the Figures, a multi-flavoring module according to one embodiment will be described. FIG. 1 shows multi-flavoring module 1 having main compartment 10 and lid 11. Lid 11 has ten individually openable sections, or sub-lids 11a, each corresponding to a module subsection 10a (not shown in FIG. 1 but shown in FIG. 2). Each lid section 11a has a tab 11b which may be configured to releasably secure section 11a to main compartment 10 of module 1. Each lid section 11a has a hinged section 11c to allow opening of individual sections 11a while remaining attached to lid 11. Lid section 11d covers subsection 10d which is configured differently than subsections 10a and may be used to store a scoop.

FIG. 2 shows multi-flavoring module 1 having main compartment 10 without lid 11. Main compartment 10 is shown having ten pie-shaped module subsections 10a separated by walls 10f which may be contiguous with main compartment 10 or may be separate, fitted structures to prevent cross-contamination between adjacent subsections. Cross-contamination between subjections may also be minimized via structures configured on the underside of lid 11 that engage or cooperate with structures of main compartment 10 to seal subjections when lid 11 is engaged with main compartment 10. In the center of module main compartment 10 may be a distinct additional subsection 10d which may be used to store a scoop. Alternatively, walls 10f may extend inward to meet in the center of main compartment 10, eliminating subsection 10d. In such an embodiment a scoop may be stored in any subsection 10a or may be stored externally.

### Example 1

A 2 lb. tub of unflavored whey protein powder is provided with a multi-flavor module shrink-wrapped on top of the protein powder container lid. The multi-flavor module is a circular plastic disc sub-divided into 10 pie-shaped subsections, each subsection being able to hold about 30 g of powdered flavor composition, the flavors being chocolate, vanilla, strawberry, cookies & cream, peanut butter, pretzel, cheesecake, caramel, banana, and mocha. The module center interior has an 11^{th} subsection that is circular and is formed to house a plastic scoop for use with the flavor compositions. The module lid is a flip top, allowing simultaneous access to all subsections.

In use, after purchase, the shrink wrap is removed allowing separation of the protein powder container and the multi-flavor module. A serving of protein powder may be dispensed to a mixing container (e.g. a shaker cup, a blender, drinking glass) using the large scoop provided in the protein powder tub. The module flip top is opened, the small scoop is removed from the central subsection, and a desired amount of the desired flavor or flavors from the module subsections is added to the protein powder. The desired liquid (e.g. water, milk) is then added for mixing and the protein powder, flavoring(s), and liquid are mixed as desired (e.g. shaking, blending, spoon agitation) for immediate consumption or for subsequent consumption e.g. after transporting to the gym. Advantageously, with these components, the flavor of the mixture can be adjusted after tasting to achieve the desired taste as well as changing the flavor of subsequent servings.

### Example 2

A 4 lb. tub of unflavored whey protein powder is provided with a multi-flavor module shrink-wrapped on top of the protein powder lid. The multi-flavor module is a circular plastic disc sub-divided into 10 pie-shaped subsections, each subsection being able to hold about 30 g of powdered flavor composition, the flavors being chocolate, vanilla, strawberry, cookies & cream, peanut butter, pretzel, cheesecake, caramel, banana, and mocha. The module lid has a closable pour spout/nozzle and is configured to rotate about the subsections to allowing pouring flavor from a desired subsection.

### Example 3

A 1.8 lb tub of unflavored whey protein isolate powder is provided with a multi-flavor module shrink-wrapped on top of the protein powder lid. The multi-flavor module is a circular plastic disc sub-divided into 10 pie-shaped subsections, each subsection being able to hold about 30 g of powdered flavor composition, the flavors being chocolate, vanilla, strawberry, cookies & cream, peanut butter, pretzel, cheesecake, caramel, banana, and mocha. The module center interior has an 11^{th} subsection that is circular and is formed to house a plastic scoop for use with the flavor compositions. The module lid is a sectional flip top with access to individual subsections via separate top sections.

In use, after purchase, the shrink wrap is removed allowing separation of the protein powder container and the multi-flavor module. A serving of protein powder may be dispensed to a mixing container (e.g. a shaker cup, a blender, drinking glass) using the large scoop provided in the protein powder tub. The module flip top is opened, the small scoop is removed from the central subsection, and a desired amount of the desired flavor or flavors from the module subsections is added to the protein powder. The desired liquid (e.g. water, milk) is then added for mixing and the protein powder, flavoring(s), and liquid are mixed as desired (e.g. shaking, blending, spoon agitation) for immediate consumption or for subsequent consumption e.g. after transporting to the gym. Advantageously, with these components, the flavor of the mixture can be adjusted after tasting to achieve the desired taste as well as changing the flavor of subsequent servings.

1. A multi-flavoring module comprising a lid and a main compartment, the main compartment configured to house a plurality of individual flavor compositions.

2. The multi-flavoring module of claim 1, wherein the main compartment is configured to house individual flavor compositions in a plurality of individual sub-containers.

3. The multi-flavoring module of claim 2, wherein the lid is one of a flip top or a screw top.

4. The multi-flavoring module of claim 1, wherein the main compartment is configured to house individual flavor compositions in a plurality of subsections.

5. The multi-flavoring module of claim 4, wherein the module is disc-shaped and the plurality of subsections are configured as pie-shaped subsections.

6. The multi-flavoring module of claim 5, wherein the number of subsections is ten.

7. The multi-flavoring module of claim 5, wherein the lid comprises separately operable sections corresponding to the main compartment subsections.

8. A customizable multi-flavoring system comprising a) a base container for providing a foodstuff base composition and b) a multi-flavoring module for providing a multi-flavoring composition, wherein the multi-flavoring module comprises a lid and a main compartment configured to house a plurality of individual flavor compositions.

9. The multi-flavoring system of claim 8, wherein the base container and the multi-flavoring module are configured with mating structural elements to associate together.

10. A method of flavoring a foodstuff, on a per-serving basis, comprising:
a. portioning a serving of the foodstuff from a base container;
b. selecting an appropriate flavor or combination of flavors from a plurality of individual flavor compositions from a multi-flavoring module;
c. adding a desired amount of the selected flavor composition; and
d. mixing the selected flavor composition and foodstuff to produce the desired flavored foodstuff.

11. The multi-flavoring module of claim 6, wherein the lid comprises separately operable sections corresponding to the main compartment subsections.

12. The customizable multi-flavoring module of claim 8, wherein the number of subsections is ten.

13. The customizable multi-flavoring system of claim 12, wherein the base container and the multi-flavoring module are configured with mating structural elements to associate together.
